(19) United States
(12) Patent Application Publication
(10) Pub. No.: US 2010/0262459 A1
(43) Pub. Date: Oct. 14, 2010

(54) Academic Achievement Improvement

(75) Inventors: Berj Akian, Hoboken, NJ (US); Stanley Watts, Nutley, NJ (US)

Correspondence Address: Ashok Tankha, 36 Greenleigh Drive, Sewell, NJ, 08080, US

(73) Assignee: ClassLink Inc.

(21) Appl. No.: 12/422,994

(22) Filed: Apr. 14, 2009

(51) Int. Cl. G06Q 10/00; G06F 15/18

(52) U.S. Cl. 705/10; 706/12

(57) ABSTRACT

Disclosed herein is a computer implemented method and system for assisting students in technology utilization to optimize the students' academic achievements based on statistical relationships between the students' academic achievements and the students' technology utilization patterns. A software agent is provided for capturing the students' technology utilization patterns. The software agent uploads the captured technology utilization patterns to an analysis server via a network. The analysis server statistically correlates the uploaded technology utilization patterns with the students' academic achievements uploaded to the analysis server. The analysis server creates benchmark technology utilization patterns using the technology utilization patterns of one or more of the students selected based on predetermined criteria. The analysis server statistically correlates the created benchmark technology utilization patterns with the captured technology utilization patterns of the students. The analysis server generates and displays reports based on the statistical correlation.

### BACKGROUND

The computer implemented method and system disclosed herein, in general, relates to transforming technology utilization patterns of students into benchmark utilization patterns associated with academic achievements. More particularly, the computer implemented method and system disclosed herein relates to assisting students in technology utilization to optimize the students' academic achievements based on statistical relationships between the students' academic achievements and the students' technology utilization patterns.

Students may use technology for a variety of purposes including recreation, communication, and instruction. Within an educational setting, for example, in a school, the aim of technology usage includes improving research and investigation skills, knowledge acquisition, language literacy, numeracy, etc. Educators increasingly incorporate technology tools and resources into the learning process with the targeted goal of improving student academic performance. The educator needs to be aware of potential statistical relationships between measured improvements in academic performance and patterns of use of specific technology tools and resources.

Usage patterns of technology relate to a student's usage of technology, for example, software applications intended to have a learning impact, software games, internet based resources, productivity software tools, etc, also referred to as instructional software tools (ISTs) over a variety of access and delivery mechanisms, for example, computers, gaming devices, mobile phones and personal digital assistants, or from any device connected to the internet. Although correlation does not necessarily imply causation, statistical and regression analysis of relationships between IST usage and academic performance may help direct further investigation of a particular IST and how various usage patterns may have differing and potentially improved academic performance results. Furthermore, as the marketplace of ISTs continues to grow in the number of choices, complexity and stated purpose, educators need improved methods and information to make better return on investment decisions on the selection of an IST and decisions on optimal usage patterns.

Students and educators have a wide range of choices in ISTs to choose from. Different ISTs may have different levels of effectiveness. Finding the most effective IST for improving academic performance may involve trial and error methods, which are unsuitable in the field of academics. Research shows that academically stronger students typically use certain ISTs more effectively than academically weaker students. The academically weak students need to be guided and assisted in optimally utilizing the ISTs based on usage patterns of the academically stronger students.

Hence, there is an unmet need for assisting students in technology utilization to optimize academic achievements of the students based on statistical relationships between the academic achievements of the students and technology utilization patterns of the students.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for assisting students in technology utilization to optimize the students' academic achievements based on statistical relationships between the students' academic achievements and the students' technology utilization patterns. The computer implemented method and system disclosed herein further assists educators and others who may have similar interests to make better returns on investment decisions on the selection of a technology and decisions on optimal usage patterns.

A software agent is provided. The software agent captures the technology patterns of the students. In an embodiment, patterns of usage of one or more instructional software tools (ISTs) by each of the students are collected. The software agent captures the technology utilization patterns across multiple end nodes. The end nodes are used by the students for the technology utilization. The end nodes are, for example, computers, gaming devices, mobile phones, personal digital assistants, etc.

The captured technology utilization patterns comprise, for example, one or more names of the ISTs used by the students, dates of usage of the ISTs, duration of the usage, names and types of the end nodes used by the students for using the ISTs, internet protocol addresses of the used end nodes, place of use of the end nodes, an indication of teacher instructed usage, etc. The captured technology utilization patterns further comprise, for example, names of websites visited by the students, dates of the visits to the websites, durations of the visits, names of end nodes used by the students for visiting the websites, and internet protocol addresses of the used end nodes.

The software agent summarizes the captured technology utilization patterns for storage and transmission efficiency. The captured technology utilization patterns are summarized at user defined intervals. The software agent uploads the captured technology utilization patterns to an analysis server via a network. The captured technology utilization patterns are uploaded to the analysis server at predefined intervals of time. The software agent also uploads the students' academic achievements to the analysis server. The analysis server statistically correlates the uploaded technology utilization patterns with the uploaded academic achievements of the students. The students' academic achievements comprise, for example, one or more grades of the students for one or more subjects, standardized test scores of the students for one or more subjects, attendance of the students, and qualitative evaluations of performance of the students in one or more subjects. The academic achievements of the students are validated prior to uploading to the analysis server. The academic achievements are uploaded by one or more users via the network. The users register with the analysis server. The users are, for example, administrators, teachers, faculty members, technical directors, parents, students, etc.

The analysis server creates benchmark technology utilization patterns based on the statistical correlation of the uploaded technology utilization patterns with the academic achievements of the students using the technology utilization patterns of one or more of the students selected based on predetermined criteria. The predetermined criteria for selecting one or more students for creating the benchmark technology utilization patterns comprises, for example, one or more grades greater than a grade threshold, the standardized test scores greater than a test score threshold, and an improvement in the grades and the standardized test scores of the students.

The analysis server statistically correlates the created benchmark technology utilization patterns with the captured technology utilization patterns of the students. The analysis server performs variance analysis of the created benchmark technology utilization patterns and the captured technology utilization patterns of the students. The analysis server generates and displays reports for each of the students based on the statistical correlation of the created benchmark technology utilization patterns with the captured technology utilization patterns. Each of the generated reports comprises, for example, one or more of feedback, recommendations, information on the created benchmark technology utilization patterns, etc.

The analysis server also generates reports for the summarized technology utilization patterns and the created benchmark technology utilization patterns. The generated reports assist the students in the technology utilization to optimize the academic achievements of the students based on the statistical relationships between the academic achievements of the students and the technology utilization patterns of the students.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of assisting students in technology utilization to optimize academic achievements of the students based on statistical relationships between the academic achievements of the students and technology utilization patterns of the students.

FIG. 2 illustrates a computer implemented system for assisting students in technology utilization to optimize academic achievements of the students based on statistical relationships between the academic achievements of the students and technology utilization patterns of the students.

FIG. 3 exemplarily illustrates the computer system employed in the end nodes used by the users and the analysis server.

FIG. 4 exemplarily illustrates a client-server relationship between multiple end nodes connected to the analysis server via a network.

FIG. 5 exemplarily illustrates instructional software tools accessible over multiple end nodes in different networks connected to the analysis server via the internet.

FIG. 6 exemplarily illustrates strategic locations for installing a software agent on each of the end nodes.

FIGS. 7A-7B exemplarily illustrate a student's technology utilization patterns captured by the software agent before and after summarization respectively.

FIG. 8 exemplarily illustrates the captured technology utilization patterns that are summarized and uploaded to the analysis server via the internet.

FIG. 9 exemplarily illustrates academic achievement information of the students that are uploaded to the analysis server via the internet.

FIG. 10 exemplarily illustrates a screen menu provided by the analysis server for selecting students whose technology utilization patterns and academic achievement information is available on the analysis server to include for statistical correlation.

FIG. 11 exemplarily illustrates a screen menu provided by the analysis server showing percentage completion of statistical correlation.

FIG. 12 exemplarily illustrates a screen menu provided by the analysis server showing completion of statistical correlation.

FIG. 13 exemplarily illustrates a screen menu provided by the analysis server for selecting students to be included for variance analysis.

FIG. 14 exemplarily illustrates a screen menu provided by the analysis server that displays the reports generated by the analysis server for review.

### DETAILED DESCRIPTION OF THE INVENTION

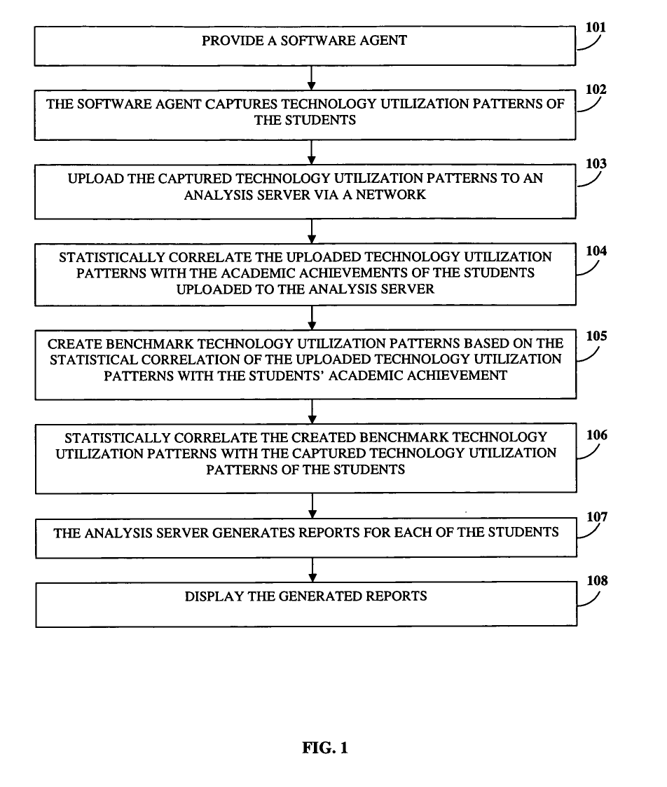

FIG. 1 illustrates a computer implemented method of assisting students in technology utilization to optimize academic achievements of the students based on statistical relationships between the academic achievements of the students and technology utilization patterns of the students. The technology utilization comprises, for example, utilization of one or more instructional software tools (ISTs). As used herein, the term “instructional software tool” refers to a software application used by students for educational purposes, either as part of the standard curriculum or as a supplementary study program. The ISTs may be provided by educational institutes, for example, schools. A software agent is provided 101. As used herein, the software agent is, for example, a standalone software application, part of a larger software application, or a software component embedded within a different software application. The software agent is provided at a strategic location, for example, on end nodes on which the students use the ISTs, installed on part of the network hardware, or as a part of the ISTs.

A student may log in to the end node or to the IST using a unique student identifier (ID) to use the IST. The software agent captures 102 the technology utilization patterns of the students. Capturing the technology utilization patterns comprises, for example, collecting patterns of usage of one or more ISTs by each of the students. The software agent captures the technology utilization patterns across multiple end nodes. The students use the end nodes, for example, computers, gaming devices, mobile phones, personal digital assistants (PDAs), etc. for the technology utilization. The captured technology utilization patterns comprise, for example, one or more names of the ISTs used by the students, dates of usage of the ISTs, duration of the usage, names and types of the end nodes used by the students for using the ISTs, internet protocol (IP) addresses of the used end nodes, place of use of the end nodes, and an indication of teacher instructed usage. The indication of teacher instructed usage allows a determination of whether the student uses the ISTs on receiving instructions from a teacher or without receiving the instructions. The captured technology utilization patterns further comprise, for example, names of websites visited by the students, dates of the visits to the websites, durations of the visits, names of the end nodes used by the students for visiting the websites, and IP addresses of the used end nodes.

In an embodiment, the software agent summarizes the captured technology utilization patterns for storage and transmission efficiency. The captured technology utilization patterns may be summarized at user defined intervals. The captured technology utilization patterns may, for example, be summarized based on the start date and stop time of usage of the IST, captured technology utilization patterns, etc.

The software agent uploads 103 the captured technology utilization patterns to an analysis server via a network. The captured technology utilization patterns may be uploaded to the analysis server at predefined intervals of time. The analysis server may have previously stored information of the students. The information comprises, for example, name, unique student IDs, class, etc. of the students. Based on the unique student ID used by a particular student to use the ISTs or access the internet at the end nodes, the analysis server recognizes and identifies the student whose technology utilization patterns are uploaded. The students' academic achievements are also uploaded to the analysis server. The students' academic achievements comprise, for example, one or more grades of the students for one or more subjects, standardized test scores of the students for one or more subjects, attendance of the students, and qualitative evaluations of performance of the students in one or more subjects.

The analysis server statistically correlates 104 the uploaded technology utilization patterns with the uploaded academic achievements of the students. The statistical correlation of the uploaded technology utilization patterns with the academic achievements of the students is herein referred to as a “first correlation”.

The software agent validates the academic achievements of the students prior to uploading to the analysis server. The validation comprises checking for missing data and erroneous syntax. For example, if the academic achievements are uploaded in the form of numerical scores, the students' academic achievements are checked to ensure no students' academic achievements are uploaded in a different form. Similarly, if standardized test scores are uploaded, the academic achievements are checked to ensure the data is the form of valid standardized test scores. If attendance of the students is being uploaded, the attendance data is checked to ensure that the data conforms to a particular predefined standard, for example, number of days absent.

The students' academic achievements may be uploaded via for example, the internet. The academic achievements may be uploaded by one or more users, for example, an administrator, a teacher, a faculty member, a technical director, a parent, a student, etc. The administrator, the teacher, the faculty member, the technical director, the parent, and the student may register with the analysis server as users prior to uploading the academic achievement information.

In an embodiment, the analysis server performs the first correlation automatically at predefined points in time. In another embodiment, the analysis server performs the first correlation on receiving a command from a user. The first correlation comprises, for example, plotting the students' academic achievements against the students' technology utilization patterns.

The analysis server creates 105 benchmark technology utilization patterns based on the first correlation using the technology utilization patterns of one or more of the students selected based on predetermined criteria. The predetermined criteria comprises, for example, one or more grades greater than a grade threshold, the standardized test scores greater than a test score threshold, and an improvement in the grades and the standardized test scores of one or more students. The students may be selected based on the performance of the students. For example, students with high scores or grades may be selected for creating the benchmark technology utilization patterns. Students with improved scores or grades may also be selected for creating the benchmark technology utilization patterns. Selecting students with high academic achievements and students exhibiting improvements in the academic achievements enables the technology utilization benchmarks to be created to correspond to high academic achievements and improvements.

The analysis server statistically correlates 106 the created benchmark technology utilization patterns with the captured technology utilization patterns of the students. The correlation of the created benchmark technology utilization patterns with the captured technology utilization patterns of the students is herein referred to as the “second correlation”. The second correlation provides information about the students that are utilizing the ISTs similar to the benchmark technology utilization patterns, and the students that have technology utilization patterns dissimilar to the benchmark technology utilization patterns. The second correlation comprises, for example, variance analysis. The variance analysis is performed between the captured technology utilization patterns and the created benchmark technology utilization patterns.

The analysis server generates 107 reports for each of the students based on the second correlation. Each of the generated reports comprises, for example, feedback, recommendations, information on the created benchmark technology utilization patterns, etc. One or more users may register with the analysis server prior to or concurrent with the steps discussed above. Each of the one or more users may be registered as an administrator, a teacher, a faculty member, a technical director, a parent, or a student. The analysis server also generates reports for the summarized technology utilization patterns and the created benchmark technology utilization patterns. The analysis server displays 108 the generated reports to the students, parents, technical directors, faculty members, or administrators. The generated reports assist the students in the technology utilization to optimize the students' academic achievements based on the statistical relationships between the students' academic achievements and the students' technology utilization patterns.

Consider an example where a faculty member registers and logs in to the analysis server. The faculty member may be interested in knowing if students in the 90^{th} percentile utilized a particular IST more than students in lower percentiles. The faculty member may also be interested in seeing if a correlation exists between the use of specific technology resources and the academic achievement information of students in the 90^{th} percentile. The faculty member selects the application software report option on the analysis server and views the technology utilization patterns of students in the 90^{th} percentile. A report containing the names of the application software used by students in the 90^{th} percentile and paradigm of usage is generated and displayed for the faculty member to view.

The displayed reports may recommend optimal strategies for efficient technology utilization for students based on the benchmark technology utilization patterns. For example, if a first student who is weak at mathematics uses a mathematics IST one hour a day, and a second student who is strong at mathematics uses the mathematics IST three hours a day, a recommendation may be made to the first student to use the mathematics IST three hours a day to improve the academic performance of the first student in mathematics.

Consider an example where Kathy, a 9^{th} grade student who is enrolled in an algebra class at her school. Her school has invested in several algebra instructional software tools (ISTs). Kathy uses an algebra IST installed on a computer in her mathematics classroom. Later that day Kathy browses the internet and utilizes a series of online web-based mathematics resources from the school media center. At the end of the day, Kathy goes to the public library and accesses her school's online resources to continue the algebra activity she started at school. Over the succeeding days, weeks, and months she accesses these school based and online based algebra resources from a number of different computers and internet access devices, both in school and outside school.

The school has installed the software agent to capture utilization of these algebra resources. Each time Kathy uses the algebra resources she must log in to the software agent by providing a unique student ID. The software agent captures and assigns usage of the mathematics resources from any computer to Kathy. Data on Kathy's utilization of these mathematics resources are summarized and periodically uploaded to the analysis server where the data is stored as Kathy's technology utilization patterns. After some time, Kathy's algebra teacher Mr. Watts becomes concerned that Kathy is not performing at her capability in the algebra class. Mr. Watts logs in to the analysis server and instructs the analysis server to run a variance analysis of Kathy's technology utilization patterns against benchmark technology utilization patterns for algebra ISTs and web resources. The analysis server generates and displays a report of the variance analysis for view by Mr. Watts. From the report generated, Mr. Watts discovers that Kathy has over-utilized one of the algebra ISTs and underutilized two other algebra ISTs. Mr. Watts reviews the missing skills and instructs Kathy to refocus her IST usage from the over-utilized IST to the underutilized ISTs.

Consider another example of Mr. Akian, who is a school faculty member and also a system administrator of the analysis server. He registers online and after a verification process he is granted a login ID to the analysis server. Mr. Akian is interested in the benchmark technology utilization patterns for students enrolled in his fourth grade classroom. Mr. Akian intends to align his IST activities and assignments around the benchmark technology utilization patterns. Mr. Akian logs in to the analysis server with his login ID and checks the benchmark technology utilization patterns for his fourth grade class level. He requests a report showing the names and technology utilization patterns of the fourth grade ISTs used in the benchmark technology utilization patterns. The report helps Mr. Akian plan his semester's activities and assignments according to the benchmark technology utilization patterns.

Consider another example of Mr. Partch, a director of technology at a local school district, who is also a system administrator of the analysis server. He is responsible for setting the software budget and executing purchase orders for ISTs for the school district. He registers online and after a verification process he is granted a login ID to the analysis server. Mr. Partch is interested in finding which of the different ISTs he purchases for the school district are included in the benchmark technology utilization patterns. Mr. Partch intends to align his IST purchases around the benchmark technology utilization patterns. Mr. Partch logs in to the analysis server with his login ID and checks the benchmark technology utilization patterns for all grade levels. He requests a report showing the names of all ISTs included in the benchmark technology utilization patterns sorted by grade levels. The report helps Mr. Partch make data driven decisions regarding purchase and renewals of the ISTs.

Consider another example of Mr. Janover, a director of curriculum at a local school district, who is also a system administrator of the analysis server. He is responsible for defining curricular goals and a teachers' professional development policy for the school district. He registers online and after a verification process he is granted a login ID to the analysis server. Mr. Janover is interested in obtaining information regarding which teachers in his district tend to better leverage the benefits of ISTs into their lessons and activities. Mr. Janover has planned an upcoming teachers' professional development event and wants to use the knowledge to better guide his decisions on how to structure staff improvement plans for the event. Mr. Janover would like to know which teachers are leaders in having their students use ISTs optimally, given the availability of benchmark technology utilization patterns. Mr. Janover logs in to the analysis server with his login ID and checks the benchmark technology utilization patterns for all grade levels. He requests a report showing the names of teachers whose students demonstrate closest correlation of individual technology utilization patterns to the benchmark technology utilization patterns. The report helps Mr. Janover organize an effective teachers' professional development event.

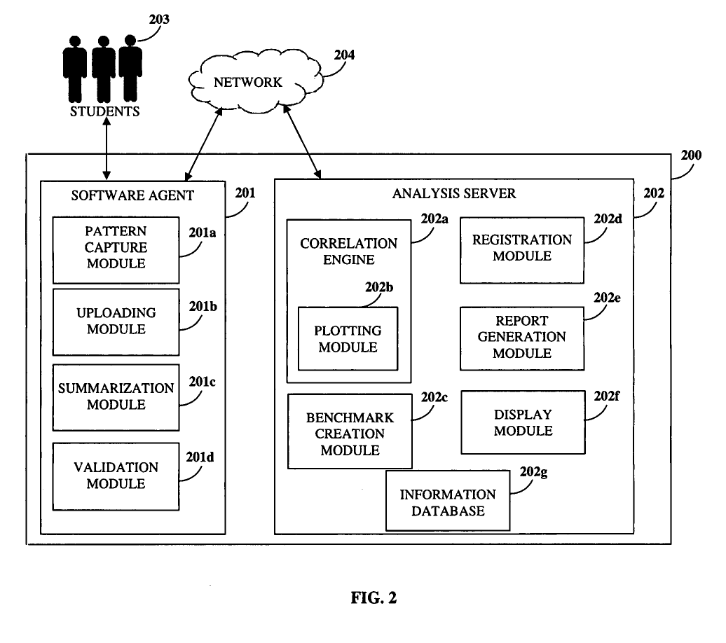

FIG. 2 illustrates a computer implemented system 200 for assisting students 203 in technology utilization to optimize academic achievements of the students 203 based on statistical relationships between the academic achievements of the students 203 and technology utilization patterns of the students 203. The technology utilization comprises utilization of one or more instructional software tools (ISTs). The computer implemented system 200 disclosed herein comprises a software agent 201 connected to an analysis server 202 via a network 204.

The software agent 201 is provided at a strategic location, for example, on end nodes on which the students 203 use the ISTs, installed on part of the network hardware, or as a part of the ISTs. The software agent 201 comprises a pattern capture module 201a, an uploading module 201b, a summarization module 201c, and a validation module 201d. The pattern capture module 201a captures the students' 203 technology utilization patterns. The pattern capture module 201a enables collection of patterns of usage of one or more ISTs by each of the students 203. The pattern capture module 201a captures the technology utilization patterns across multiple end nodes. The end nodes are used by the students 203 for the technology utilization. When a student 203 launches an IST, the pattern capture module 201a records a start event of the utilization of the IST. The pattern capture module 201a records, for example, start date stamp, start time stamp, etc. When the students 203 terminate the IST, the pattern capture module 201a also records the stop date stamp, the stop time stamp, and application process identifier.

The summarization module 201c summarizes the captured technology utilization patterns for storage and transmission efficiency. The summarization module 201c summarizes the captured technology utilization patterns at user defined intervals. The summarization module 201c summarizes the captured technology utilization patterns based on the start date and stop time of usage of the IST, captured technology utilization patterns, etc. For example, if an IST is used for 60 minutes, only one instance of the IST will be recorded for the 60 minutes. Summarization of the technology utilization patterns reduces the amount of information to be transmitted and stored.

The validation module 201d validates the academic achievements of the students 203. The students' 203 academic achievements comprise, for example, grades of the students 203 for one or more subjects, standardized test scores of the students 203 for one or more subjects, attendance of the students 203, qualitative evaluations of performance of the students 203 in one or more subjects, etc. The uploading module 201b uploads the captured technology utilization patterns and the validated academic achievements to the analysis server 202. The uploading module 201b uploads the captured technology utilization patterns to the analysis server 202 at predefined intervals of time.

The analysis server 202 comprises a correlation engine 202a, a benchmark creation module 202c, a registration module 202d, a report generation module 202e, a display module 202f, and an information database 202g. The registration module 202d registers one or more users with the analysis server 202. Each of the users is registered, for example, as an administrator, a teacher, a faculty member, a technical director, a parent, or one of the students 203. The correlation engine 202a statistically correlates the uploaded technology utilization patterns with the uploaded academic achievements of the students 203. The correlation engine 202a comprises a plotting module 202b for plotting the students' 203 academic achievements against the students' 203 technology utilization patterns. The benchmark creation module 202c creates benchmark technology utilization patterns based on the statistical correlation of the uploaded technology utilization patterns with the academic achievements of the students 203 using the technology utilization patterns of one or more of the students 203 selected based on predetermined criteria. The predetermined criteria comprises, for example, one or more grades greater than a grade threshold, the standardized test scores greater than a test score threshold, and an improvement in the grades and the standardized test scores of one or more students 203.

The correlation engine 202a then statistically correlates the created benchmark technology utilization patterns with the captured technology utilization patterns of the students 203. As an example, a student 203 Sally plays a game using mathematics skills on a gaming device for a total of 165 minutes over a 3 week period. Another student 203 Bill uses the same game for a total of 150 minutes. A third student 203 Dave uses the same game for a total of 30 minutes. Sally and Bill are among the 90th percentile, whereas Dave is among the 50th percentile. The correlation engine 202a correlates the duration of usage of the game using mathematics skills with the percentile scores of the students 203.

The report generation module 202e generates reports for each of the students 203 based on the statistical correlation of the created benchmark technology utilization patterns with the captured technology utilization patterns. Each of the generated reports comprises, for example, one or more of feedback, recommendations, and information on the created benchmark technology utilization patterns. The report generation module 202e also generates reports for the summarized technology utilization patterns and the created benchmark technology utilization patterns. The display module 202f displays the generated reports. The information database 202g stores the information about the students 203, one or more of the registered users, the uploaded technology utilization patterns, the uploaded academic achievement information, the benchmark technology utilization patterns, and the generated reports.

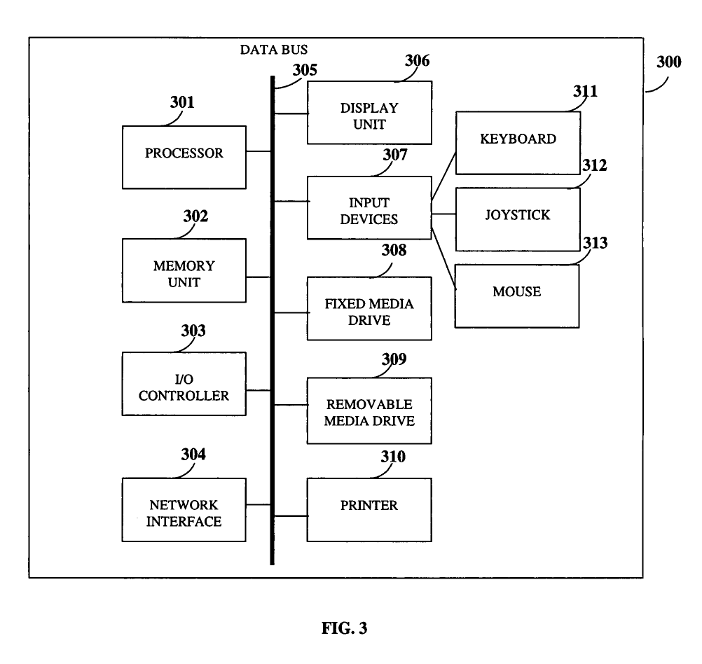

FIG. 3 exemplarily illustrates the computer system 300 employed in the end nodes used by the users and the analysis server 202. The end nodes are, for example, computers, gaming devices, mobile phones, personal digital assistants, etc. The software agent 201 is deployed on the computer system 300 of the end node. The end nodes communicate with each other via, for example, a local area network (LAN), a wide area network (WAN), etc. The computer system 300 comprises a processor 301, a memory unit 302 for storing programs and data, an input/output (I/O) controller 303, and a display unit 306 communicating via a data bus 305. The memory unit 302 comprises a random access memory (RAM) and a read only memory (ROM). The computer system 300 comprises one or more input devices 307, for example, a keyboard 311 such as an alphanumeric keyboard, a mouse 313, a joystick 312, etc. The computer system 300 communicates with other computer systems through a network interface 304, comprising, for example, Ethernet, LAN, etc.

The computer system 300 further comprises a fixed media drive 308 and a removable media drive 309 for receiving removable media. The computer system 300 further comprises output devices, for example, a printer 310 for receiving and reading digital data on a compact disk, a digital video disk or other medium. Computer applications or programs are used for operating the computer system 300. The programs are loaded onto the fixed media drive 308 and into the memory unit 302 of the computer system 300 via the removable media drive 309. Applications are executed by double clicking a related icon displayed on the display unit 306 using the mouse 313 or through other input devices 307.

The computer system 300 of the end nodes employs an operating system for performing multiple tasks. The operating system manages execution of the software agent 201 provided on the end nodes. The operating system further manages security of the computer system 300, peripheral devices connected to the computer system 300, and network connections. The operating system employed on the computer system 300 recognizes keyboard inputs of the students 203, output display, files and directories stored locally on a fixed media drive 308, etc. Different programs, for example, web browser, e-mail application, etc. initiated by the students 203 are executed by the operating system with the help of the processor 301, for example, a central processing unit (CPU). The operating system monitors the use of the processor 301. The operating system schedules the work done by the processor 301 in the form of a process or a thread, depending on the operating system. The processes and threads are signals sent by the software agent 201 to the CPU.

Instructions for executing the software agent 201 are retrieved by the CPU from the program memory in the form of signals. Location of the instructions in the program memory is determined by a program counter (PC). The program counter stores a number that identifies the current position in the program of the software agent 201. The instructions fetched by the CPU from the program memory after being processed are decoded. After processing and decoding, the instructions are executed. The CPU comprises an arithmetic and logic unit for performing mathematical and logical operations on the instructions. The instructions comprises, for example, capturing the technology utilization patterns of the students 203, uploading the captured technology utilization patterns to an analysis server 202 via the network 204, etc. The students 203 interact with the computer system 300 using a GUI of the display unit 306.

The computer system 300 of the analysis server 202, typically, employs the architecture as illustrated in FIG. 3. The end nodes are connected to the analysis server 202 via the network 204. The analysis server 202 employs an operating system to execute the functions, for example, statistically correlating the uploaded technology utilization patterns, creating benchmark technology utilization patterns based on the statistical correlation of the uploaded technology utilization patterns, statistically correlating the created benchmark technology utilization patterns with the captured technology utilization patterns of the students 203, etc. The processor 301 of the computer system 300 employed in the analysis server 202 executes requests and instructions of the end nodes connected to the analysis server 202 via the network 204. Output sent by the processor 301 of the computer system 300 on the analysis server 202 comprises, for example, reports for each of the students 203 based on the statistical correlation of the created benchmark technology utilization patterns with the captured technology utilization patterns. The computer system 300 on the analysis server 202 transfers the reports to the end nodes for display on the display unit 306 of the computer system 300 on the end nodes. A printed copy of the reports can be obtained using the printer 310.

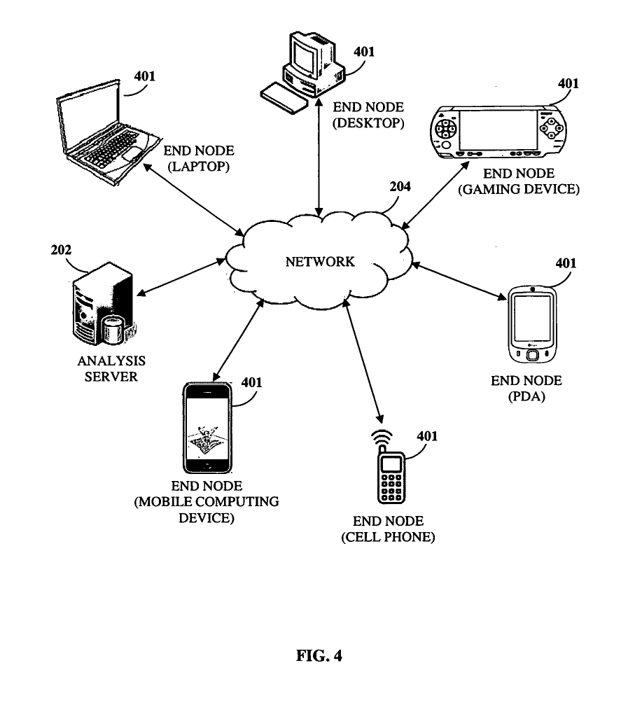

FIG. 4 exemplarily illustrates a client-server relationship between multiple end nodes 401 connected to the analysis server 202 via a network 204, for example, the internet 504. The end nodes 401, for example, a laptop, a desktop, a gaming device, PDA, a cell phone, a mobile computing device, in different networks, for example, a local area network (LAN) 503, a wide area network (WAN) 505, etc. are connected to the analysis server 202 via the internet 504. The LAN 503 comprises different network topologies. The LAN 503 uses different network protocols for enabling communication between the end nodes 401. The LAN 503, for example, comprises a peer-to-peer architecture, or a client-server architecture. The physical layer of the LAN 503 is, for example, made of twisted-pair wire, coaxial cables, fiber optic cables, etc.

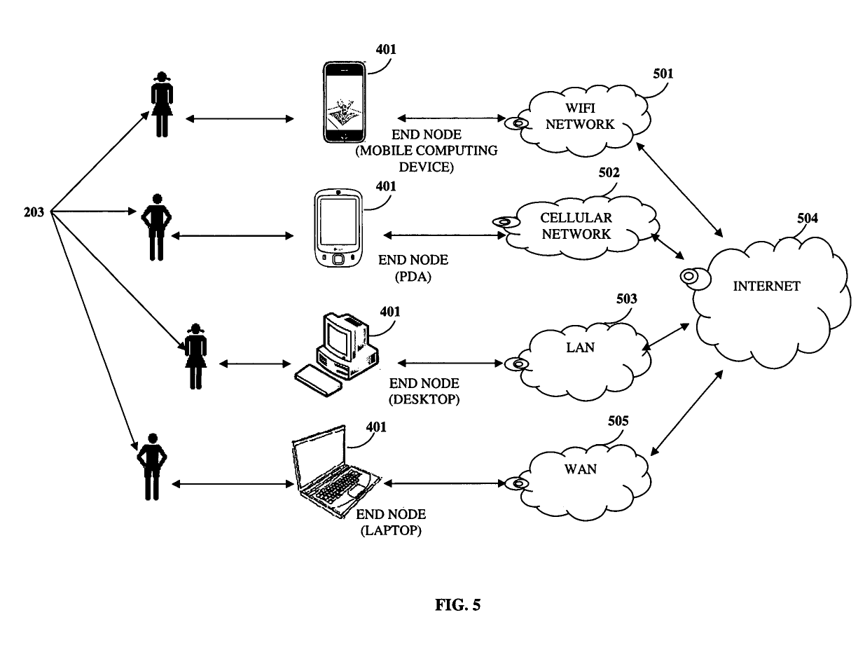

The students 203 may log in to any of the end nodes 401 to utilize the ISTs. ISTs accessible over multiple end nodes 401 in different networks connected to the analysis server 202 via the internet 504 are exemplarily illustrated in FIG. 5. For example, the mobile computing device is connected to the internet 504, via a WiFi network 501. The PDA is connected to the internet 504, via a cellular network 502. The desktop is connected to the internet 504 via a LAN 503. The laptop is connected to the internet 504 via a WAN 505.

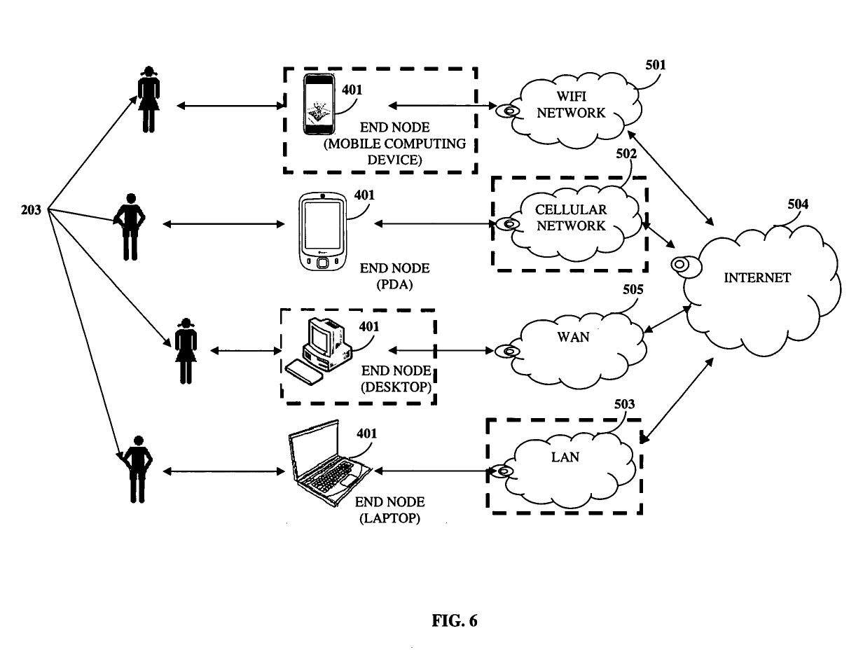

The software agent 201 is installed in a strategic location for capturing technology utilization patterns. The software agent 201 may be included directly on the end nodes 401, installed as a component of an IST, or installed on a networking connection between the end nodes 401 and IST. The dashed boxes in FIG. 6 exemplarily illustrate the strategic locations for installing the software agent 201. For example, in FIG. 6, the software agent 201 is installed on the mobile computing device, the cellular network 502, the desktop, and the LAN 503.

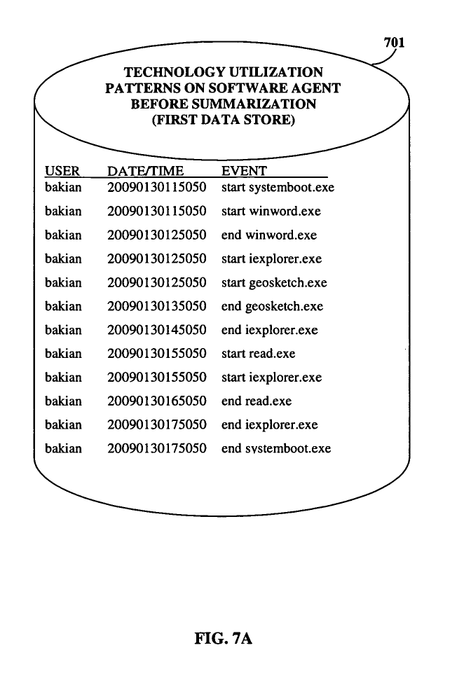

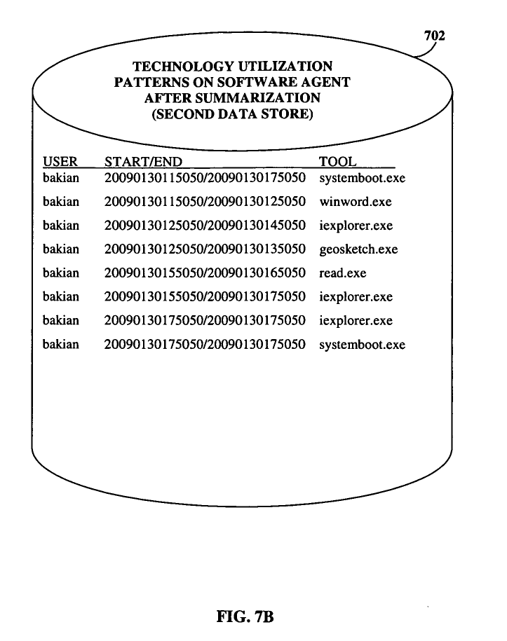

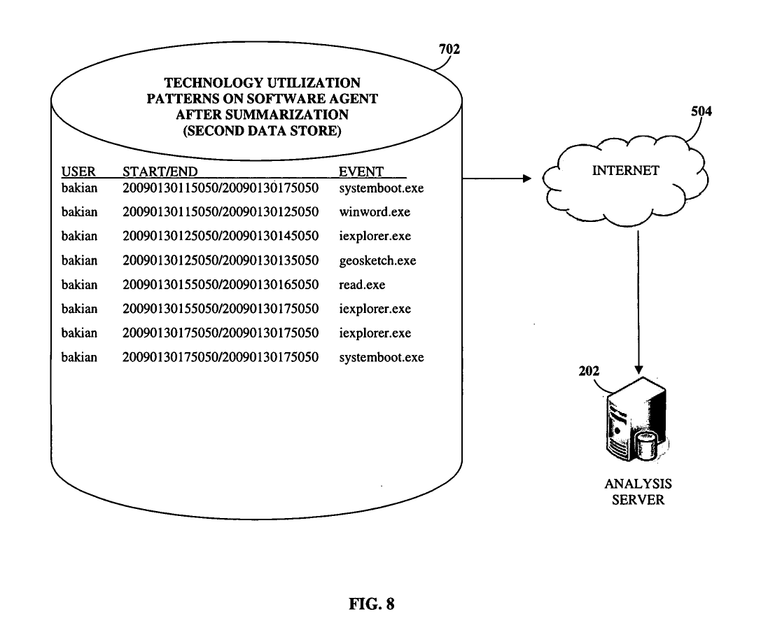

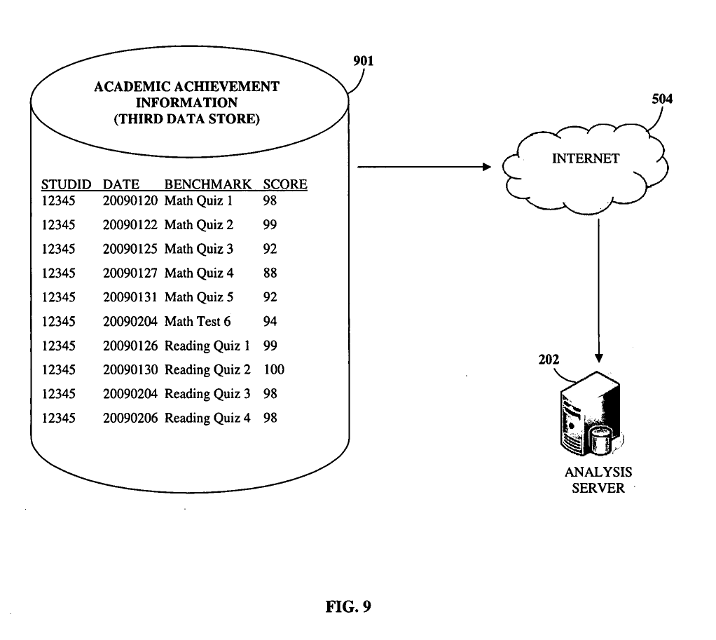

Consider an example where a student 203 logs into a laptop and utilizes the ISTs. The software agent 201 captures the technology utilization patterns. The captured technology utilization patterns are summarized for storage and transmission efficiency. The technology utilization patterns comprise, for example, the name of the student 203, duration of usage of the particular event by the student 203 and names of each of the events. A student's 203 technology utilization patterns captured by the software agent 201 and stored in a first data store 701 on the software agent 201 before summarization are exemplarily illustrated in FIG. 7A. The student's 203 technology utilization patterns captured by the software agent 201 and stored in a second data store 702 on the software agent 201 after summarization are exemplarily illustrated in FIG. 7B. The summarized technology utilization patterns are uploaded to the analysis server 202 from the second data store 702 via the internet 504 as exemplarily illustrated in FIG. 8. The academic achievements of the student 203, for example, student identification, date, subject, and the test scores of the student 203 are also uploaded from a third data store 901 on the software agent 201 to the analysis server 202 via the internet 504 as exemplarily illustrated in FIG. 9. The academic achievement information of each of the students 203 is uploaded manually or automatically from the end node 401.

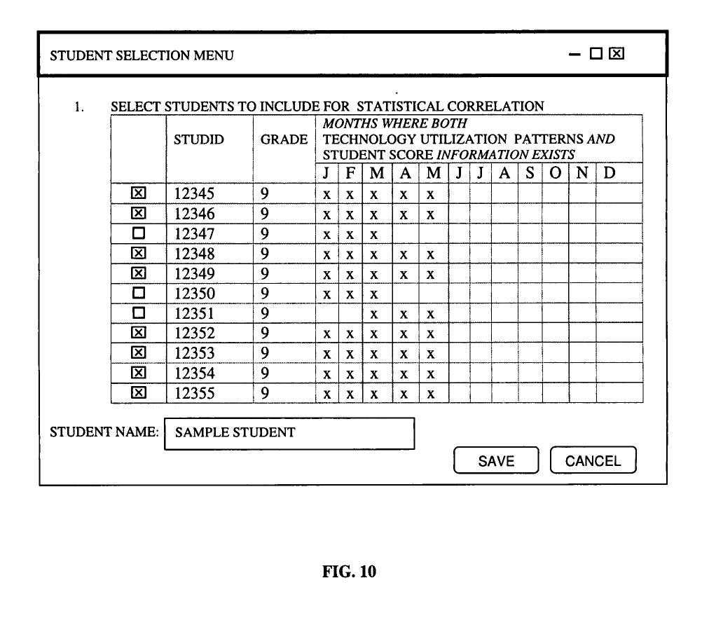

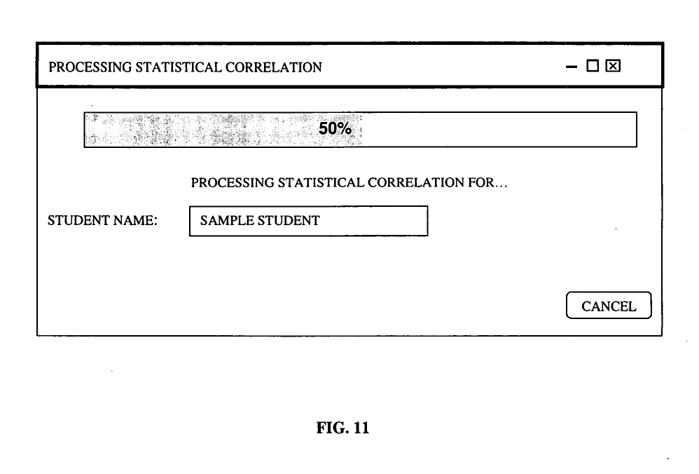

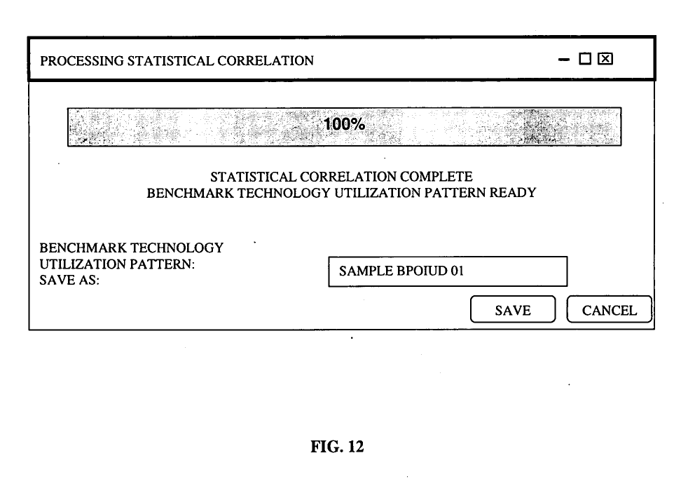

FIG. 10 exemplarily illustrates a screen menu provided by the analysis server 202 for selecting students 203 whose technology utilization patterns and academic achievement information is available on the analysis server 202 to include for statistical correlation. The students 203 are automatically or manually selected based on predetermined criteria as explained in the detailed description of FIG. 1. The selected student's name is entered in the “student name” field of the screen menu. The technology utilization patterns and academic achievements of the selected student 203 will be included for statistical correlation. The technology utilization patterns of the students 203 are organized in a table, for example, by months of captured technology utilization patterns. The analysis server 202 statistically correlates the captured technology utilization patterns of the selected students 203 with the academic achievements of the selected students 203. FIG. 11 exemplarily illustrates a screen menu provided by the analysis server 202 showing percentage completion of statistical correlation. The statistical correlation is performed between academic achievements of the students 203 and the captured technology utilization patterns of the students 203 for creating a benchmark technology utilization pattern. FIG. 12 exemplarily illustrates a screen menu provided by the analysis server 202 showing completion of statistical correlation. The benchmark technology utilization patterns created from the statistically correlated technology utilization patterns and academic achievements of the students 203 are saved in the analysis server 202 using a “save as” option provided on the screen menu.

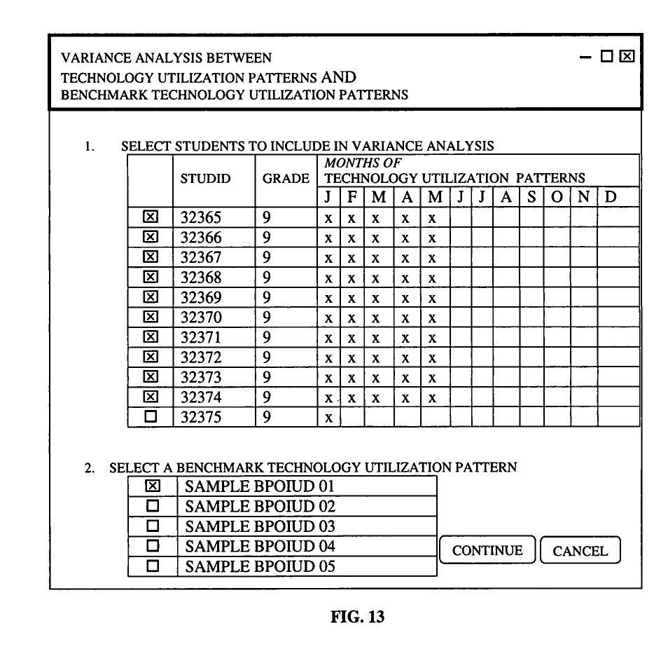

FIG. 13 exemplarily illustrates a screen menu provided by the analysis server 202 for selecting students 203 to be included for variance analysis. The technology utilization patterns of the selected students 203 are statistically correlated with benchmark technology utilization patterns for performing the variance analysis. The technology utilization patterns of the students 203 are organized in a table, for example, by months of captured technology utilization patterns. The benchmark technology utilization patterns to be included for variance analysis is selected from the table provided on the screen menu.

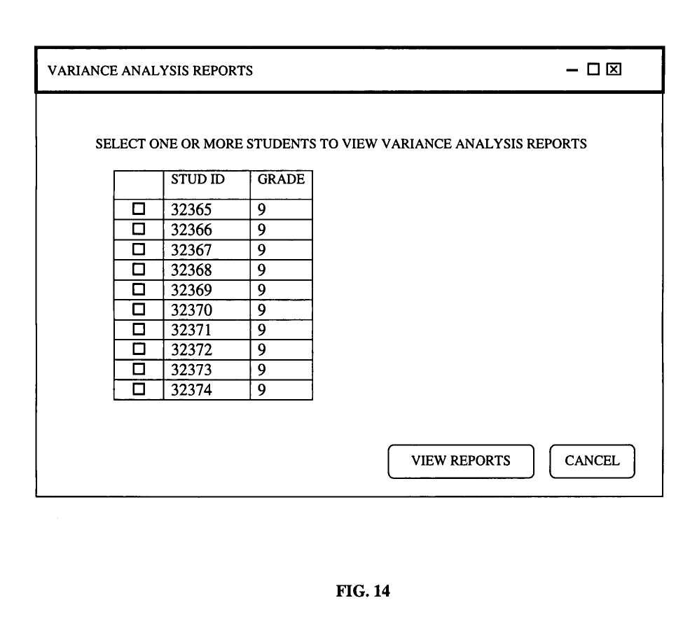

FIG. 14 exemplarily illustrates a screen menu provided by the analysis server 202 that displays the reports generated by the analysis server 202 for review. The report of each of the students 203 is selected from a table. The table is a list comprising student identification, student grade, etc. The reports of the selected students 203 are displayed to the users for reviewing.

Consider an example of a student 203 Michael who logs on to an end node 401 provided with the software agent 201. The pattern capture module 201a captures data on utilization of different ISTs and other application software used by Michael, the duration of usage of the ISTs and the application software by Michael, names of websites visited by Michael, duration of visit of the websites by Michael, the name of the end node 401 used by Michael, and the IP address of the end node 401. The captured information is summarized and periodically uploaded to the analysis server 202 where the uploaded information is stored together as Michael's technology utilization data.

Consider another example of Miss Schuerman, a middle school principal, who would like to use some of her budget to help purchase and implement ISTs for her science program, as science has been identified as an area with scope for improvement. Miss Schuerman meets several vendors offering a variety of software and online solutions; however, none of the vendors are able to provide data proving that students 203 who use a particular vendor's products tend to perform better at tests. Miss Schuerman's school and a few other middle schools in the neighboring communities have an analysis server 202. Miss Schuerman checks her school's analysis server 202 for science ISTs included in the benchmark technology utilization patterns. Miss Schuerman also asks some of her colleagues at the other middle schools to share information with her regarding which science ISTs her colleagues used, and which of the ISTs were included in the benchmark technology utilization patterns of the respective middle schools. Miss Schuerman is then able to make a purchasing decision based on the information provided by her colleagues and her school's analysis server 202. She is also able to monitor over time if the use of the ISTs are helping to improve her students' 203 academic achievements, using her school's analysis server 202.

Consider another example of a school administrator Mr. Mack, who logs in to the analysis server 202 to view reports on the technology utilization patterns of the students 203. Mr. Mack wants to see a list of all the websites visited by the students 203 on the end nodes 401 to determine which web sites are most often visited by students 203 but have no academic value to the students 203. Mr. Mack instructs the report generation module 202e to generate a report of web utilization by the students 203. A report containing a list of names of the websites visited by the students 203, duration of visit, names of the students 203 who visited the websites, and the end nodes 401 used by the students 203 to visit the websites is generated. Mr. Mack then filters the list to view the websites that are in no way related to the benchmark technology utilization patterns. A list of websites that seemingly have no instructional contribution is obtained. Mr. Mack reviews the list and makes decisions on which sites should be considered for filtering during certain hours of the day or for blocking altogether.

It will be readily apparent that the various methods and algorithms described herein may be implemented in a computer readable medium appropriately programmed for general purpose computers and computing devices. A processor, for example, one or more microprocessors, central processing unit (CPU) devices, computing devices, microcontrollers, digital signal processors or like devices, will receive instructions from a memory or like device, and execute those instructions; thereby performing one or more processes defined by those instructions. Further, programs that implement such methods and algorithms will be stored and transmitted using a variety of media, for example computer readable media, in a number of manners. In one embodiment, hard-wired circuitry or custom hardware may be used in place of, or in combination with, software instructions for implementation of the processes of various embodiments. Thus, embodiments are not limited to any specific combination of hardware and software. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory. Volatile media include Dynamic Random Access Memory (DRAM), which typically constitutes the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the information database 202g, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, for example, tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of assisting students in technology utilization to optimize academic achievements of said students based on statistical relationships between said academic achievements of the students and technology utilization patterns of the students, comprising the steps of:
providing a software agent;
capturing said technology utilization patterns of the students by said software agent;
uploading said captured technology utilization patterns to an analysis server via a network;
statistically correlating said uploaded technology utilization patterns with the academic achievements of the students uploaded to said analysis server;
creating benchmark technology utilization patterns based on said statistical correlation of the uploaded technology utilization patterns with the academic achievements of the students using the technology utilization patterns of one or more of the students selected based on predetermined criteria;
statistically correlating said created benchmark technology utilization patterns with the captured technology utilization patterns of the students; and
generating and displaying reports for each of the students based on said statistical correlation of the created benchmark technology utilization patterns with the captured technology utilization patterns, wherein each of said generated reports comprises one or more of feedback, recommendations, and information on the created benchmark technology utilization patterns;
whereby the generated reports assist the students in said technology utilization to optimize the academic achievements of the students based on said statistical relationships between the academic achievements of the students and the technology utilization patterns of the students.

2. The computer implemented method of claim 1, further comprising the step of summarizing the captured technology utilization patterns prior to said uploading to the analysis server for storage and transmission efficiency, wherein the captured technology utilization patterns are summarized at user defined intervals.

3. The computer implemented method of claim 1, wherein the step of capturing the technology utilization patterns comprises the step of collecting patterns of usage of one or more instructional software tools by each of the students.

4. The computer implemented method of claim 1, wherein the technology utilization patterns are captured across a plurality of end nodes, wherein said end nodes are used by the students for the technology utilization.

5. The computer implemented method of claim 4, wherein the captured technology utilization patterns comprise one or more names of instructional software tools used by the students, dates of usage of said instructional software tools, duration of said usage, names and types of the end nodes used by the students for using the instructional software tools, internet protocol addresses of said used end nodes, place of use of the end nodes, and an indication of teacher instructed usage.

6. The computer implemented method of claim 4, wherein the captured technology utilization patterns comprise names of websites visited by the students, dates of said visits to said websites, durations of the visits, names of end nodes used by the students for visiting the websites, and internet protocol addresses of said used end nodes.

7. The computer implemented method of claim 1, wherein the academic achievements of the students comprise one or more grades of the students for one or more subjects, standardized test scores of the students for said one or more subjects, attendance of the students, and qualitative evaluations of performance of the students in the one or more subjects.

8. The computer implemented method of claim 7, wherein the predetermined criteria for selecting the one or more students for creating the benchmark technology utilization patterns comprises one or more of said grades greater than a grade threshold, said standardized test scores greater than a test score threshold, and an improvement in the grades and the standardized test scores of the one or more students.

9. The computer implemented method of claim 1, further comprising the step of validating the academic achievements of the students prior to said uploading to the analysis server.

10. The computer implemented method of claim 1, further comprising the step of registering one or more users with the analysis server, wherein each of said one or more users is registered as one of an administrator, a teacher, a faculty member, a technical director, a parent, and a student.

11. The computer implemented method of claim 1, wherein the captured technology utilization patterns are uploaded to the analysis server at predefined intervals of time.

12. The computer implemented method of claim 1, further comprising the step of generating reports for summarized technology utilization patterns and the created benchmark technology utilization patterns.

13. A computer implemented system for assisting students in technology utilization to optimize academic achievements of said students based on statistical relationships between said academic achievements of the students and technology utilization patterns of the students, comprising:
a software agent comprising:
a pattern capture module for capturing said technology utilization patterns of the students;
an uploading module for uploading said captured technology utilization patterns to an analysis server via a network;
said analysis server, comprising:
a correlation engine for statistically correlating said uploaded technology utilization patterns with the academic achievements of the students uploaded to the analysis server, wherein said correlation engine further statistically correlates created benchmark technology utilization patterns with the captured technology utilization patterns of the students;
a benchmark creation module for creating said benchmark technology utilization patterns based on said statistical correlation of the uploaded technology utilization patterns with the academic achievements of the students using the technology utilization patterns of one or more of the students selected based on predetermined criteria;
a report generation module for generating reports for each of the students based on said statistical correlation of the created benchmark technology utilization patterns with the captured technology utilization patterns, wherein each of said generated reports comprises one or more of feedback, recommendations, and information on the created benchmark technology utilization patterns; and
a display module for displaying said generated reports.

14. The computer implemented system of claim 13, wherein the correlation engine comprises a plotting module for plotting the academic achievements of the students against the technology utilization patterns of the students.

15. The computer implemented system of claim 13, wherein said software agent further comprises a summarization module for summarizing the captured technology utilization patterns for storage and transmission efficiency, wherein said summarization module summarizes the captured technology utilization patterns at user defined intervals.

16. The computer implemented system of claim 13, wherein said pattern capture module enables each of the students to collect patterns of usage of one or more instructional software tools.

17. The computer implemented system of claim 13, wherein said pattern capture module captures the technology utilization patterns across a plurality of end nodes, wherein said end nodes are used by the students for the technology utilization.

18. The computer implemented system of claim 13, wherein the academic achievements of the students comprise one or more grades of the students for one or more subjects, standardized test scores of the students for said one or more subjects, attendance of the students, and qualitative evaluations of performance of the students in the one or more subjects.

19. The computer implemented system of claim 18, wherein the predetermined criteria for selecting the one or more students for creating the benchmark technology utilization patterns comprises one or more of said grades greater than a grade threshold, said standardized test scores greater than a test score threshold, and an improvement in the grades and the standardized test scores of the one or more students.

20. The computer implemented system of claim 13, wherein said software agent further comprises a validation module for validating the academic achievements of the students prior to uploading to the analysis server.

21. The computer implemented system of claim 13, wherein the analysis server further comprises a registration module for registering one or more users, wherein each of said one or more users is registered as one of an administrator, a teacher, a faculty member, a technical director, a parent, and a student.

22. The computer implemented system of claim 13, wherein said uploading module uploads the captured technology utilization patterns to the analysis server at predefined intervals of time.

23. The computer implemented system of claim 13, wherein said report generation module generates reports for summarized technology utilization patterns and the created benchmark technology utilization patterns.

24. The computer implemented system of claim 13, wherein the analysis server further comprises an information database for storing information about the students, one or more registered users, said uploaded technology utilization patterns, said uploaded academic achievement information, the benchmark technology utilization patterns, and the generated reports.

25. A computer program product comprising computer executable instructions embodied in a computer-readable medium, wherein said computer program product comprises:
a first computer parsable program code for providing a software agent;
a second computer parsable program code for capturing technology utilization patterns of students;
a third computer parsable program code for summarizing said captured technology utilization patterns of said students;
a fourth computer parsable program code for uploading said captured technology utilization patterns to an analysis server;
a fifth computer parsable program code for statistically correlating said uploaded technology utilization patterns with the academic achievements of the students uploaded to said analysis server via a network;
a sixth computer parsable program code for creating benchmark technology utilization patterns based on said statistical correlation of the uploaded technology utilization patterns with the academic achievements of the students using the technology utilization patterns of one or more of the students selected based on predetermined criteria;
a seventh computer parsable program code for statistically correlating said created benchmark technology utilization patterns with the captured technology utilization patterns of the students;
an eighth computer parsable program code for generating reports for each of the students based on said statistical correlation of the created benchmark technology utilization patterns with the captured technology utilization patterns, wherein each of said generated reports comprises one or more of feedback, recommendations, and information on the created benchmark technology utilization patterns; and a ninth computer parsable program code for displaying said generated reports.
